(19) United States
(12) Patent Application Publication
(10) Pub. No.: US 2024/0119360 A1
(43) Pub. Date: Apr. 11, 2024

(54) ADAPTING MACHINE LEARNING MODELS FOR DOMAIN-SHIFTED DATA

(71) Applicant: QUALCOMM Incorporated, San Diego, CA (US)

(72) Inventors: Hyesu LIM, Seongnam-si (KR); Byeonggeun KIM, Seoul (KR); Sungha CHOI, Goyang-si (KR)

(21) Appl. No.: 18/338,174

(22) Filed: Jun. 20, 2023

Related U.S. Application Data
(60) Provisional application No. 63/377,477, filed on Sep. 28, 2022.

(51) Int. Cl. G06N 20/00

(52) U.S. Cl. CPC G06N 20/00

(57) ABSTRACT

Certain aspects of the present disclosure provide techniques and apparatuses for adapting a machine learning model for inferencing against a target data set in a shifted domain from a source data set used to train the machine learning model. An example method generally includes identifying one or more domain-sensitive layers in a machine learning model based on differences between outputs generated by one or more layers in the machine learning model for inputs in a source domain and inputs in a shifted domain. Normalizing values are updated for each respective domain-sensitive layer of the one or more domain-sensitive layers based on a mixing factor, fixed normalizing values for data in the source domain, and calculated normalizing values for data in the shifted domain. The updated normalizing values are applied to each respective domain-sensitive layer of the one or more domain-sensitive layers in the machine learning model.

### CROSS-REFERENCE TO RELATED APPLICATIONS

This application claims priority to and benefit of U.S. Provisional Patent Application Ser. No. 63/377,477, entitled “Adapting Machine Learning Models for Domain-Shifted Data,” filed Sep. 28, 2022, and assigned to the assignee hereof, the entire contents of which are hereby incorporated by reference.

### INTRODUCTION

Aspects of the present disclosure relate to machine learning models, and more specifically to adapting machine learning models to perform accurate inferences on domain-shifted data sets.

Machine learning models, such as artificial neural networks (ANNs), convolutional neural networks (CNNs), or the like, can be used to perform various actions on input data. These actions may include, for example, data compression, pattern matching (e.g., for biometric authentication), object detection (e.g., for surveillance applications, autonomous driving, or the like), natural language processing (e.g., identification of keywords in spoken speech that triggers execution of specified operations within a system), or other inference operations in which models are used to predict something about the state of the environment from which input data is received. These models may generally be trained using a source data set, which may be different from a target data set that the machine learning models use as input for inferencing. For example, in some scenarios in which machine learning models are trained and deployed for use in object avoidance tasks in autonomous driving, a source data set may include images, video, or other content captured in a specific environment with specific equipment in a specific state (e.g., an urban or otherwise highly built environment, with imaging devices having specific noise and optical properties, that are relatively clean).

Generally, machine learning models generate accurate inferences when deployed in a similar environment as the environment from which the source data used to train these machine learning models was obtained (e.g., when the source data set and target data set are in the same, or at least substantially similar, domains). However, when the domain in which the target data set is captured shifts relative to the source data set, inference performance may decrease. For example, a model trained in an urban or otherwise highly built environment may not perform inferences as accurately for data captured in a rural environment (and vice versa). In another example, inference performance may decrease when the target data set includes data captured in different weather or environmental conditions, or when blur or other transformations are introduced in an imaging system.

### BRIEF SUMMARY

Certain aspects provide a processor-implemented method for adapting a machine learning model for inferencing against a target data set in a shifted domain from a source data set used to train the machine learning model. An example method generally includes identifying one or more domain-sensitive layers in a machine learning model based on differences between outputs generated by one or more layers in the machine learning model for inputs in a source domain and inputs in a shifted domain. Normalizing values are updated for each respective domain-sensitive layer of the one or more domain-sensitive layers based on a mixing factor, fixed normalizing values for data in the source domain, and calculated normalizing values for data in the shifted domain. The updated normalizing values are applied to each respective domain-sensitive layer of the one or more domain-sensitive layers in the machine learning model.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain features of various aspects of the present disclosure and are therefore not to be considered limiting of the scope of this disclosure.

FIG. 1 illustrates an example pipeline for adapting a machine learning model for inferencing against a target data set in a shifted domain from a source data set used to train the machine learning model, according to aspects of the present disclosure.

FIG. 2 illustrates an example test-time normalization layer used to adapt a machine learning model for inferencing against a target data set in a shifted domain from a source data set used to train the machine learning model, according to aspects of the present disclosure.

FIG. 3 illustrates an example of adapting a machine learning model for inferencing against a target data set in a shifted domain from a source data set used to train the machine learning model, according to aspects of the present disclosure.

FIG. 4 illustrates example operations for adapting a machine learning model for inferencing against a target data set in a shifted domain from a source data set used to train the machine learning model, according to aspects of the present disclosure.

FIG. 5 illustrates an example implementation of a processing system on which adaptation of a machine learning model for inferencing against a target data set in a shifted domain from a source data set used to train the machine learning model can be performed, according to aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide techniques and apparatuses for adapting machine learning models to accurately perform inferences on domain-shifted data.

Various applications use machine learning models to process streaming data and generate outputs which can subsequently be used to perform various specified actions within a system. For example, streaming audio data can be captured and processed by a machine learning model to authenticate or otherwise identify a user of a system (e.g., where multiple users, having different voice profiles, use the same system, and the system is customized based on the identity of the user). In another example, streaming video data can be captured and processed by a machine learning model to identify objects within a scene captured by a camera, identify the distance of these objects to a reference datum point, and perform other identification and ranging tasks (e.g., for autonomous driving tasks, surveillance, and the like). In still further examples, time-series signal measurements (e.g., of channel quality information (CQI), channel state information (CSI), or the like) in wireless communications systems can be processed by a machine learning model for various predictive signal and/or beam management techniques, such as predicting beamforming patterns to use for communications between a network entity (e.g., a base station) and a user equipment (UE) in a wireless communications system.

In many cases, these machine learning models may be trained on data that is in a different domain from input data on which these machine learning models perform inferences. For example, a machine learning model may be trained using a “clean” or idealized data set representing a best-case or idealized environment from which data is captured. In another example, a machine learning model may be trained using a source data set captured from a specific environment. However, machine learning models may generally be deployed in environments outside of these best-case environments or the environments from which the source data set is captured, and thus, the data input into the machine learning model at inference time may be in a shifted domain relative to the source data set. As an illustrative example, a “clean” data set in a video streaming application may include data captured in a sufficiently bright environment using an imaging device free from damage or obstructions (e.g., scratches, dirt, and/or oil on lens elements that can degrade the imagery captured by the imaging device), while a data set used as input into the machine learning model at inference time may be captured in a dim environment using an imaging device having various properties that affect the fidelity of imagery captured by the imaging device.

Because the data input into the machine learning model at inference time may be in a shifted domain relative to the source data set, the performance of the machine learning model may be reduced relative to the performance of the machine learning model when performing inferences on data in the source data set. The magnitude of the performance reduction may be related to the magnitude of the shift between the source data set and the data input into the machine learning model at inference time. Generally, smaller domain shifts between the source data set and the data input into the machine learning model at inference time may result in better inference performance than larger domain shifts between the source data set and the data input into the machine learning model at inference time. For example, inference performance for a model performing inferences on received input images taken with an imaging system having different, but similar, optical characteristics to that used to capture a source data set may be similar to the inference performance for the model performing inferences on the source data set. Inference performance, however, for a model performing inferences on received input images having additional transformations, such as blurring or noise, may be worse than inference performance for the same model performing inferences on received input images taken with an imaging system having different, but similar, optical characteristics to that used to capture a source data set.

To account for changes in inference performance due to domain shifts between the source data set used to train the machine learning model and a target data set, various normalization techniques can be used. For example, batch normalization can be used to normalize input activation based on the mean and variance of the training data set during training and based on running estimates of input data statistics at inference time. However, machine learning models that use batch normalization may not significantly compensate for domain shifts between the source data set used to train the machine learning models and a target data set (e.g., a data set of inputs on which the machine learning model is to perform various inferencing operations). For example, in an autonomous driving scenario, a model using batch normalization may continue to be sensitive to domain shifts. Such domain shifts may include, for example, changes between the environment in which the source data set was captured (e.g., historical data used to train the machine learning model) and the environment in which the target data set was captured (e.g., at inference time). In another example, test-time adaptation techniques can be used to estimate various normalization statistics from current test inputs. However, these techniques may assume large test batch sizes and a single or limited domain shift. Because these assumptions may not be realistic, real-world performance of machine learning models using test-time adaptation may also show that these machine learning models are sensitive to various domain shifts on input data relative to a source data set used to train these machine learning models.

Aspects of the present disclosure provide techniques and apparatuses for adapting a machine learning model based on normalization values associated with a source data set and normalization values associated with a target data set (which may be domain shifted relative to the source data set). As discussed in further detail herein, the degree to which normalization values associated with the source data set and the corresponding degree to which normalization values associated with the target data set may be set based on the domain-shift sensitivity of each layer of the machine learning model. Generally, layers that are non-domain-sensitive or have limited sensitivity to domain shifts may more heavily weight the normalization values associated with the source data set, while layers that are domain-sensitive may more heavily weight the normalization values associated with the target data set so that the unique properties of the target data set are accounted for when inferencing is performed on the target data set. By doing so, aspects of the present disclosure may provide for improved inference performance across different data domains. Further, a cross-domain model need not be trained using a training data set including data from a large number of domains, which may reduce the amount of computational resources used to train a machine learning model to accurately generate inferences across these different data domains relative to the amount of resources used to train a machine learning model using a training data set including data from a large number of domains.

### Example Test Time Normalization for Adapting Machine Learning Models to Domain-Shifted Data

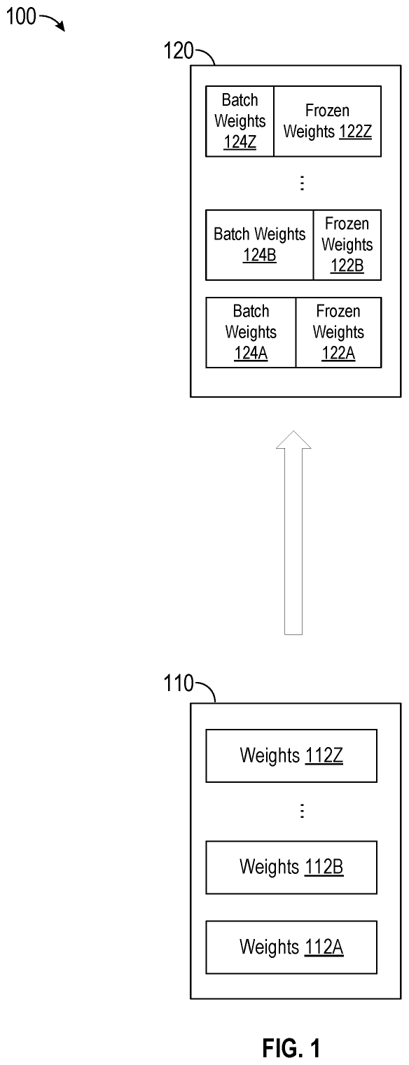

FIG. 1 depicts an example pipeline 100 for adapting a machine learning model for inferencing against a target data set in a shifted domain from a source data set used to train the machine learning model, according to aspects of the present disclosure.

The pipeline 100 generally includes a plurality of layers with weights 112A-112Z of a trained machine learning model 110. The machine learning model 110 may be represented by the expression f_{θ}:x→y and may be trained on a source data set in a source-data-set-specific domain. In some aspects, the weights 112A-112Z associated with the different layers of the machine learning model 110 may be generated based on batch normalization techniques applied to the source data set in which statistical normalization measures, such as an average μₛ and a variance (or standard deviation σₛ) are calculated over the source data set used to train the machine learning model.

To allow for the machine learning model to adapt to domain shifts between the source data set and a target data set on which inferencing is performed, the layers in the machine learning model 110 may be analyzed in a post-training phase to determine the domain sensitivity of each layer. In some aspects, to determine the domain sensitivity of each layer in the machine learning model 110, the source data set may be transformed into a target data set by applying one or more domain shifting transformations to the source data set. For example, these transformations may include (but are not limited to) adding noise to images in the source data set, removing noise from images in the source data set, converting images in the source data set from color to black-and-white, introducing color shifts to images in the source data set, introducing visual artifacts (e.g., blurring, positional transformations, etc.) to images in the source data set, and so on. While the above discusses transformations which may be applied to image data, it should be recognized that other transformations may be applied to image data, and different transformations may be applied to non-image data (e.g., audio, text, etc.) as appropriate.

During this post-training phase, batch normalization layers may be transformed into test-time normalization layers by adjusting the normalizing values applied in each of these layers based on whether a layer is domain-sensitive and, if so, the extent to which a layer is domain-sensitive. To do so, for an l^{th} layer and an input data minibatch size of B, the input to this l^{th} layer may be represented as zᵢₙ^{(l)}={z₁^{(l)}, z₂^{(l)}, . . . , z_{B}^{(l)}} where z_{b}^{(l)}∈ [symbol] ^{CHW}, C represents a channel, H represents a height dimension, and W represents a width dimension. Normalizing statistical values, μᵢₙ^{(l)} and σᵢₙ^{2(l)} (e.g., the mean and variance values), for input zᵢₙ^{(l)} (e.g., for the minibatch input into the l^{th} layer) may be computed according to the equations:

$${μ}_{in}^{( l )} = \frac{1}{BHW} {\sum }_{b}^{B} {\sum }_{h}^{H} {\sum }_{w}^{W} {z}_{bhw} ∈ {ℝ}^{C} and$$

$${σ}_{in}^{2 ( l )} = \frac{1}{BHW} {\sum }_{b}^{B} {\sum }_{h}^{H} {\sum }_{w}^{W} {( {z}_{bhw} - {μ}_{in}^{( l )} )}^{2} ∈ {ℝ}^{C}$$

where b∈B represents the b^{th} portion of a minibatch, h∈H represents a height component of the portion of the minibatch, and w∈W represents a width component of the portion of the minibatch.

Normalizing statistical values μₛ^{(l)} and σₛ^{2(l)} for a source data set may be estimated with μᵢₙ^{(l)} and σᵢₙ^{2(l)} using various techniques, such as an exponential moving average over the source data set. The mean μₛ^{(l)} for the source data set may be represented by the expression:

μₛ^{(l)}≈ [symbol] [μᵢₙ^{(l)}]

Meanwhile, the variance σₛ^{2(l)} for the source data set may be represented by the expression:

σₛ^{2(l)}≈ [symbol] [σᵢₙ²(l)]

In batch normalization layers, such as those in the machine learning model 110 illustrated with the weights 112A-112Z, an input zᵢₙ may be normalized using the normalizing statistical values μₛ^{(l)} and σₛ^{2(l)}, and the normalized input may be transformed with learnable parameters γ^{(l)} and β^{(l)}, where γ^{(l)} corresponds to a learned scaling parameter for normalizing an input and β^{(l)} corresponds to a learned bias term for normalizing an input.

To allow for the machine learning model to adapt to domain-shifted data and generate accurate inferences from data in a different domain from the source data set used to train the machine learning model, normalizing statistical values for the source data set and the target data set may be combined, as illustrated in machine learning model 120. For each layer in the machine learning model for which normalization is performed, a learnable interpolating weight α^{(l)} ∈ [symbol] ^{C} (also referred to as a mixing factor), ranging from [0, 1], may be applied to the normalizing statistical values for the source data set. Similarly, the difference between 1 and the learnable interpolating weight α^{(l)} may be applied to the normalizing statistical values for the target data set. Generally, the interpolating weight (or mixing factor) indicates the degree to which a layer l and channel c are affected by a domain shift between the source data set used to train the machine learning model and a target data set representing data received at inference time for which the machine learning model is to generate one or more inferences. Larger values of α^{(l)} (e.g., values of α^{(l)} closer to 1) generally indicate that a layer has a lower degree of domain sensitivity than smaller values of α^{(l)} (e.g., values of α^{(l)} closer to 0).

As illustrated in FIG. 1, weights for a layer A in the machine learning model 110 (e.g., the weights 112A) may be replaced by frozen weights 122A and batch weights 124A in the machine learning model 120. Generally, frozen weights (e.g., 122A-122Z), as discussed in further detail below, may be the weights associated with the training data used to train the machine learning model 110, while the batch weights (e.g., 124A-124Z) may be weights associated with inputs based on which the machine learning model 120 generates inferences. Similar replacements may be performed for layers B through Z in the machine learning model 120, where Z is any positive integer. In this example, frozen weights 122A-122Z (collectively referred to as “frozen weights 122”) may represent the weights associated with the source data set, and batch weights 124A-124Z (collectively referred to as “batch weights 124”) may represent the weights associated with the target data set, with the relative size of the frozen weights 122 and the batch weights 124 for each layer in the machine learning model 120 corresponding to different values of α^{(l)} for the corresponding layer. By freezing the weights associated with the source data set, knowledge gained by training the machine learning model using the source data set may be preserved in the machine learning model to different degrees depending on the extent to which a layer in the machine learning model is domain sensitive.

In this example, layer A may have a value of α^{(l)} close to 0.5, indicating that the frozen weights 122A and the batch weights 124A have an equal influence on the output generated by this layer of the machine learning model 120. Layer B, meanwhile, may have a value of α^{(l)} that is less than 0.5, indicating that this layer is relatively sensitive to domain shifts and thus that the weights associated with the target data set should have a greater influence on the outputs generated by layer B. Thus, the batch weights 124B may be weighted more heavily than the frozen weights 122B in processing an input through layer B of the machine learning model 120. Finally, as illustrated, layer Z may have a value of α^{(l)} that is greater than 0.5, indicating that this layer is relatively insensitive to domain shifts and thus that the weights associated with the source data set can have a greater influence on the outputs generated by layer Z without adversely affecting the performance of machine learning model 120. Thus, the frozen weights 122Z may be weighted more heavily than the batch weights 124Z in processing an input through layer Z of the machine learning model 120.

The normalization values applied to a layer l and channel c in the machine learning model 120 may be represented by the equations:

μ=αμᵢₙ+(1−α)μₛ∈ [symbol] ^{C}

and

σ²=ασᵢₙ²+(1−α)σₛ²+α(1−α)(μᵢₙ−μₛ)²∈ [symbol] ^{C}

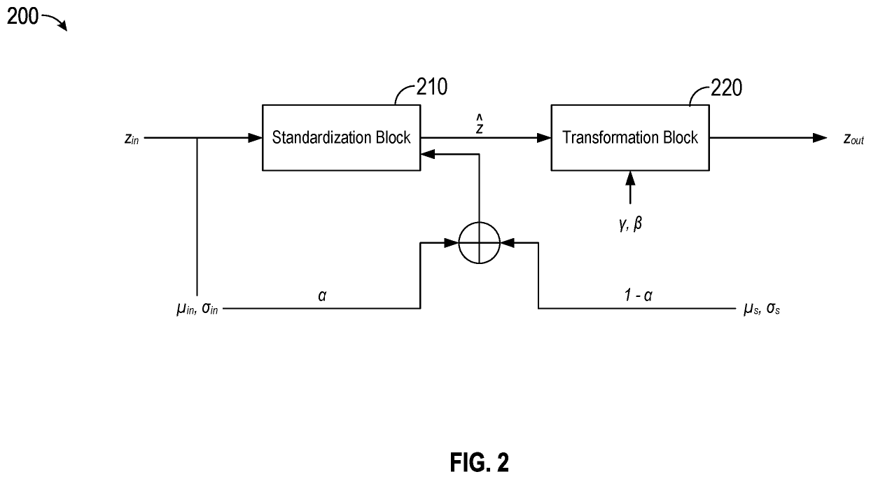

FIG. 2 illustrates an example test-time normalization layer 200 used to adapt a machine learning model for inferencing against a target data set in a shifted domain from a source data set used to train the machine learning model, according to aspects of the present disclosure. As discussed, the test-time normalization layer 200 may be used as a batch normalization layer in a machine learning model so that normalized layers in a machine learning model can adjust for domain shifts between the source data set used to train these machine learning models and a target data set including data for which the machine learning model is to generate one or more inferences.

As illustrated, the test-time normalization layer 200 includes a standardization block 210 and a transformation block 220. The standardization block 210 receives an input zᵢₙ and generates an activation \hat{z} based on a mixing factor α defined for the layer, calculated normalizing values μᵢₙ and σᵢₙ for the target data set, and frozen normalizing values μₛ and σₛ for the source data set. Generally, activation \hat{z} may be represented by the equation:

$$\hat{z} = \frac{{z}_{in} - μ}{σ}$$

The transformation block 220 uses the activation \hat{z} and generates an output zₒᵤₜ by applying an affine transformation using parameters γ and β, discussed above, to activation \hat{z}. Output zₒᵤₜ may be represented by the equation:

zₒᵤₜ=γ·\hat{z}+β

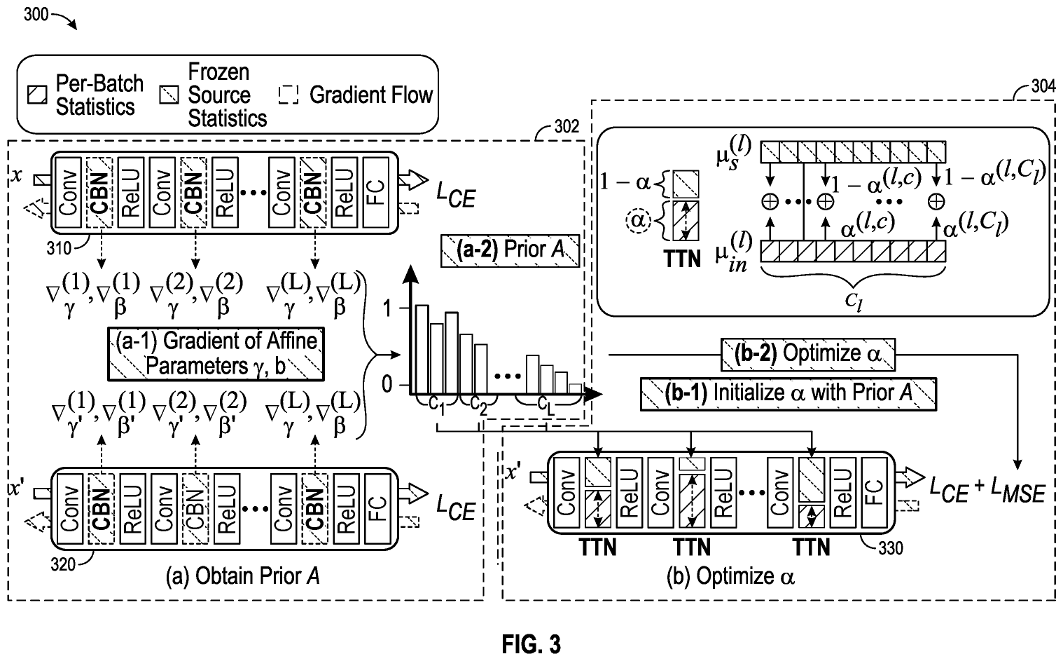

FIG. 3 illustrates an example pipeline 300 for adapting a machine learning model for inferencing against a target data set in a shifted domain from a source data set used to train the machine learning model, according to aspects of the present disclosure.

Generally, the pipeline 300 may include a first stage 302 in which a prior [symbol] is generated and a second stage 304 in which the mixing factor α is refined based on initializing α with prior [symbol] (e.g., a learned probability distribution over a set of options for the source data set). To obtain the prior [symbol] , a pre-trained model (e.g., a model including one or more batch normalization layers) may be used at block 310 to generate an output (e.g., an inference) for an input x from the source data set using a machine learning model including a plurality of convolutional layers, conditional batch normalization (CBN) layers, rectifier linear unit (ReLU) layers, and a fully connected layer that generates the final output, and at block 320 to generate an output for an input x′ from a target data set. Generally, the target data set may simulate a domain shift relative to the source data set such that a pairing of an input in the source data set and a corresponding shifted input in the target data set include semantically similar information (e.g., a color image and a monochrome image of the same subject). Because the blocks 310 and 320 use the same machine learning model, and thus the same standardization parameters, to generate activations \hat{z}^{(l,c)} for both x and x′, the activation \hat{z}^{(l,c)} for input x may be treated as ground-truth data against which the activation \hat{z}′^{(l,c)} is compared. The difference between \hat{z}^{(l,c)} and \hat{z}′^{(l,c)} may represent the difference between input activations z^{(l,c)} and z′^{(l,c)} caused by a domain shift applied to x to generate x′.

When the difference between \hat{z}^{(l,c)} and \hat{z}′^{(l,c)} is large (e.g., exceeds a threshold value, is in the top percentile bin in a distribution of layer/channel domain sensitive metrics, etc.), it may be determined that the normalization statistics at (l, c) are targets for adaptation towards the target data set and away from the source data set. Because the output activation \hat{z} is an input to a transformation block (e.g., the transformation block 220 illustrated in FIG. 2) which applies an affine transformation to the output activation \hat{z}, gradients of affine parameters γ and β can be used to measure the difference between \hat{z}^{(l,c)} and \hat{z}′^{(l,c)}.

To calculate the difference between \hat{z}^{(l,c)} and \hat{z}′^{(l,c)}, gradients ∇_{γ} and ∇_{β} may be collected using the pre-trained model, which uses the normalization statistics generated for the source data set, and a cross-entropy loss [symbol] _{CE} between the input x and the shifted input x′. For each layer l∈[1, . . . , L] and for each channel c∈[1, . . . , Cₗ] for each layer, the direction of a gradient pair is compared, and an average of similarity values over the data in the target data set is calculated. A gradient similarity s^{(l,c)} may be calculated according to the equations:

$$s = \frac{1}{N} {\sum }_{i - 1}^{N} \frac{{g}_{i}^{\cdot } {g}_{i}^{′}}{‖ {g}_{i} ‖ ‖ {g}_{i}^{′} ‖} ∈ ℝ and$$

$${s}^{( l , c )} = \frac{1}{2} ( {s}_{γ}^{( l , c )} + {s}_{β}^{( l , c )} ) ∈ ℝ$$

where (g, g′) corresponds to (∇γ^{(l,c)},Δ_{γ′}^{(l,c)}) and (∇_{β}^{(l,c)},∇_{β′}^{(l,c)}) for s_{γ}^{(l,c)} and s_{β}^{(l,c)}, respectively. To integrate s_{γ}^{(l,c)} and s_{β}^{(l,c)}, the average of s_{γ}^{(l,c)} and s_{β}^{(l,c)} may be computed and denoted as s^{(l,c)} ∈[0,1].

For layers and channels in a machine learning model that are domain sensitive (e.g., have a large difference between activations generated for an input x and a shifted input x′), greater weight may be applied to normalization statistics associated with the target data set to which the shifted input x′ belongs than to normalization statistics associated with the source data set to which the input x belongs. To allow for this greater weight to be applied to the normalization statistics associated with the target data set, min-max normalization may be calculated over the reverse of the similarity scores for the layers and channels of the machine learning model, resulting in the calculation of a relative difference. This relative difference may be magnified to result in the generation of prior [symbol] . Prior [symbol] may be represented by the equation:

[symbol]

={v(1−[s^{(1,.)},s^{(2,.)}, . . . ,s^{(L,.)}])}²

where s^{(l,)} represents all channels in layer l and v(⋅) represents a min-max normalization function.

After obtaining the prior [symbol] using a pre-trained machine learning model with batch normalization layers, the batch normalization layers of the pre-trained machine learning model may be replaced with test-time normalization layers that use the combined statistics of the source data set and the target data set to process an input. In doing so, the trained weights of the model, including affine parameters, may be frozen, and the normalization statistics may be modified to use statistical values from both the source data set and the target data set, modified by the mixing factor α. To do so, at block 330, the mixing factor α may be defined as a learnable parameter initialized as q, representing a layer and channel for which the normalization statistics are to be corrected using the normalization statistics associated with the target data set.

The mixing factor α may be optimized or otherwise set in an effort to make the combined statistics correctly normalize data when input is sampled from an arbitrary target domain different from the source domain in which the source data set lies. To simulate a domain shift from the source domain to the target domain, the target data set (representing a domain-shifted version of the source data set), a cross-entropy loss [symbol] _{CE}, and a mean-squared error loss [symbol] _{MSE} may be used to allow the model to consistently generate inferences given input x from the source data set or shifted input x′ from the target data set and to prevent α from diverging significantly from [symbol] , respectively. The mean-squared error loss term may be defined by the equation:

[symbol]

_{MSE}= [symbol] _{CE}+λ [symbol] _{MSE}

Meanwhile, the total loss function may be defined by the equation:

[symbol]

= [symbol] _{CE}+λ [symbol] _{MSE}

where λ is a learned regularization weight hyperparameter.

### Example Adaptation of Machine Learning Models to Domain-Shifted Data

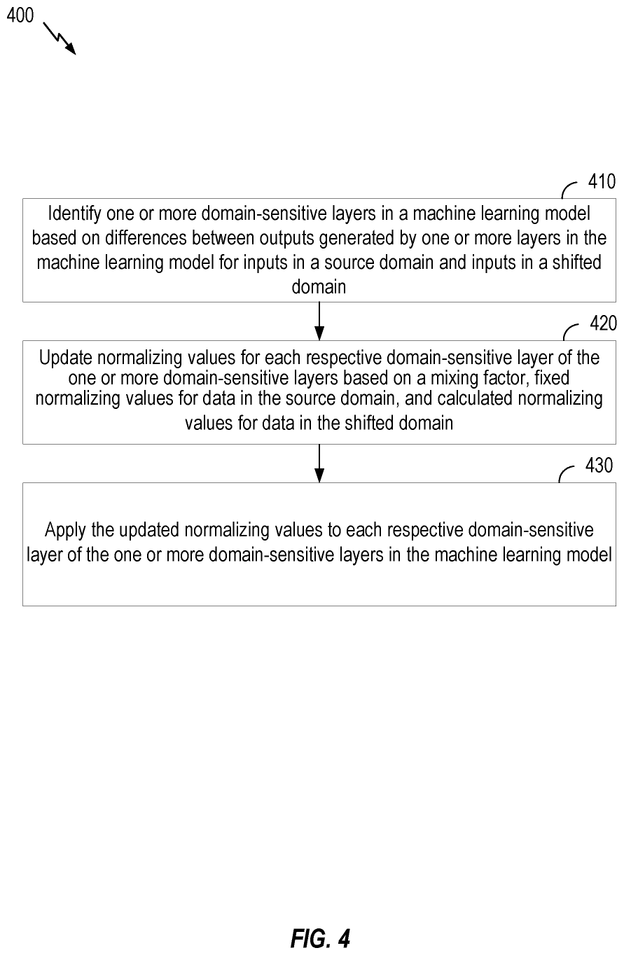

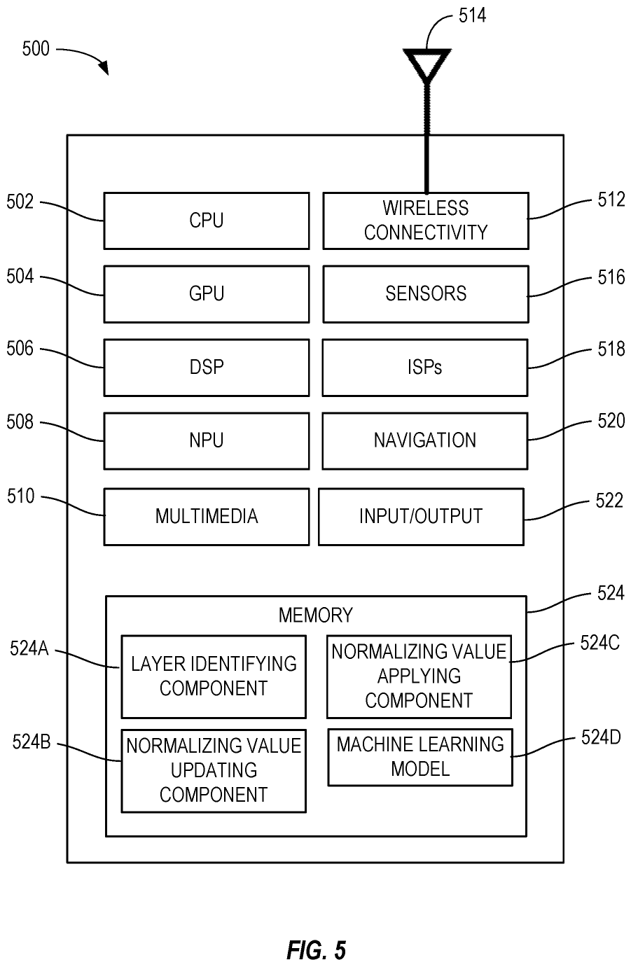

FIG. 4 illustrates example operations 400 for adapting a machine learning model for inferencing against a target data set in a shifted domain from a source data set used to train the machine learning model, according to aspects of the present disclosure. The operations 400 can be performed, for example, by a computing system, such as a user equipment (UE) or other computing device, such as that illustrated in FIG. 5, on which a pre-trained machine learning model can be adjusted prior to deployment (e.g., during or after training) or on which a machine learning model is deployed.

As illustrated, the operations 400 begin at block 410, with identifying one or more domain-sensitive layers in a machine learning model based on differences between outputs generated by one or more layers in the machine learning model for inputs in a source domain and inputs in a shifted domain.

In some aspects, identifying the one or more domain-sensitive layers in the machine learning model may be performed on a per-layer basis. For each layer in the machine learning model, a source domain gradient vector for the respective layer may be calculated based on forward-propagating and backpropagating the inputs in the source domain through the respective layer. Similarly, a target domain gradient vector for the respective layer may be calculated based on forward-propagating and backpropagating the inputs in the shifted domain through the respective layer. A similarity score may be calculated between the source domain gradient vector and the domain-shifted gradient vector. This similarity score may, in some aspects, include a distance score between the source domain gradient vector and the domain-shifted gradient vector, a normalized cosine similarity score, or the like. In some aspects, the domain-sensitive layers may be identified as layers for which the similarity scores are above a threshold percentile of scores across similarity scores calculated for the layers in the machine learning model. In some aspects, each layer of the machine learning model for which normalization is applied may be considered a domain-sensitive layer in the machine learning model, and these layers may have varying degrees of batch sensitivity.

In some aspects, the inputs in the source domain may be inputs corresponding to a source data set used to train the machine learning model. Inputs in the shifted domain (also referred to as the target domain) may be inputs generated by applying one or more transformations to inputs in the source data set.

In some aspects, the inputs in the shifted domain may be inputs obtained at inference time.

At block 420, the operations 400 proceed with updating normalizing values for each respective domain-sensitive layer of the one or more domain-sensitive layers based on a mixing factor, fixed normalizing values for data in the source domain, and calculated normalizing values for data in the shifted domain.

In some aspects, the normalizing values for each respective domain-sensitive layer are updated further based on the mixing factor applied to the normalizing values for data in the source domain and 1 minus the mixing factor applied to the normalizing values for data in the shifted domain. As discussed, larger values for the mixing factor may correspond to lower degrees of domain sensitivity, while smaller values for the mixing factor may correspond to higher degrees of domain sensitivity. Generally, as the degree of domain sensitive increases, the amount by which normalization statistics for data in the target domain (e.g., data received at inference time) influence the overall output of a layer of the machine learning model increases.

In some aspects, the normalizing values for the data in the shifted domain comprise an average and a variance (or a standard deviation) calculated over the data in the shifted domain.

In some aspects, the mixing factor may be a learnable parameter fixed for the machine learning model prior to deployment. As discussed, to learn the value of the mixing factor, a prior may be obtained based on a difference between output activations generated for an input x in the source domain and a shifted input x′ in the target domain. The mixing factor may be initialized as the prior, then refined based on a cross-entropy loss between inputs x and x′ and a mean-squared error loss between the mixing factor and the prior.

In some aspects, the normalizing values may be defined for the data in the source domain as one or more constants in the machine learning model. By doing so, learned knowledge about the source domain may be retained regardless of the degree to which layers in the machine learning model are adjusted to take into account information about data in the shifted (target) domain.

At block 430, the operations 400 proceed with applying the updated normalizing values to each respective domain-sensitive layer of the one or more domain-sensitive layers in the machine learning model.

In some aspects, the operations 400 further include deploying the machine learning model with the updated normalizing values for each respective domain-sensitive layer of the one or more domain-sensitive layers in the machine learning model.

In some aspects, the operations 400 further include receiving input data. One or more inferences are generated based on the received input data and the machine learning model with the updated normalizing values for each respective domain-sensitive layer of the one or more domain-sensitive layers in the machine learning model, and one or more actions are taken based on the generated one or more inferences. These actions may include, for example, compressing data (e.g., using an encoder of an autoencoder neural network or a generative adversarial network), decompressing data (e.g., using a decoder of an autoencoder neural network), identifying objects in visual content (still images or streams of images), predicting the future motion of objects in visual content, and/or other tasks for which machine learning models can be trained and used to generate inferences on input data.

### Example Processing System for Adapting Machine Learning Models to Domain-Shifted Data

FIG. 5 depicts an example processing system 500 for adapting machine learning models to domain-shifted data, such as described herein for example with respect to FIG. 4.

The processing system 500 includes a central processing unit (CPU) 502, which in some examples may be a multi-core CPU. Instructions executed at the CPU 502 may be loaded, for example, from a program memory associated with the CPU 502 or may be loaded from a memory 524.

The processing system 500 also includes additional processing components tailored to specific functions, such as a graphics processing unit (GPU) 504, a digital signal processor (DSP) 506, a neural processing unit (NPU) 508, a multimedia processing unit 510, and a wireless connectivity component 512.

An NPU, such as the NPU 508, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 508, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this data piece through an already trained model to generate a model output (e.g., an inference).

In some implementations, the NPU 508 is a part of one or more of the CPU 502, the GPU 504, and/or the DSP 506.

In some examples, the wireless connectivity component 512 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. The wireless connectivity component 512 is further coupled to one or more antennas 514.

The processing system 500 may also include one or more sensor processing units 516 associated with any manner of sensor, one or more image signal processors (ISPs) 518 associated with any manner of image sensor, and/or a navigation processor 520, which may include satellite-based positioning system components (e.g., GPS or GLONASS), as well as inertial positioning system components.

The processing system 500 may also include one or more input and/or output devices 522, such as screens, touch-sensitive surfaces (including touch-sensitive displays), physical buttons, speakers, microphones, and the like.

In some examples, one or more of the processors of the processing system 500 may be based on an ARM or RISC-V instruction set.

The processing system 500 also includes a memory 524, which is representative of one or more static and/or dynamic memories, such as a dynamic random access memory, a flash-based static memory, and the like. In this example, the memory 524 includes computer-executable components, which may be executed by one or more of the aforementioned processors of the processing system 500.

In particular, in this example, the memory 524 includes a layer identifying component 524A, a normalizing value updating component 524B, a normalizing value applying component 524C, and a machine learning model 524D. The depicted components, and others not depicted, may be configured to perform various aspects of the methods described herein.

Generally, the processing system 500 and/or components thereof may be configured to perform the methods described herein.

Notably, in other aspects, elements of the processing system 500 may be omitted, such as where the processing system 500 is a server computer or the like. For example, the multimedia processing unit 510, the wireless connectivity component 512, the sensor processing units 516, the ISPs 518, and/or the navigation processor 520 may be omitted in other aspects. Further, elements of the processing system 500 may be distributed, such as training a model and using the model to generate inferences.

### Example Clauses

Implementation details of various aspects of the present disclosure are described in the following numbered clauses.

Clause 1: A processor-implemented method, comprising: identifying one or more domain-sensitive layers in a machine learning model based on differences between outputs generated by one or more layers in the machine learning model for inputs in a source domain and inputs in a shifted domain; updating normalizing values for each respective domain-sensitive layer of the one or more domain-sensitive layers based on a mixing factor, fixed normalizing values for data in the source domain, and calculated normalizing values for data in the shifted domain; and applying the updated normalizing values to each respective domain-sensitive layer of the one or more domain-sensitive layers in the machine learning model.

Clause 2: The method of Clause 1, wherein identifying the one or more domain-sensitive layers in the machine learning model comprises, for each respective layer of the layers in the machine learning model: calculating a source domain gradient vector for the respective layer based on forward-propagating and backpropagating the inputs in the source domain through the respective layer; calculating a domain-shifted gradient vector for the layer based on forward-propagating and backpropagating the inputs in the shifted domain through the respective layer; and calculating a similarity score between the source domain gradient vector and the domain-shifted gradient vector, wherein a similarity score above a threshold percentile of scores across similarity scores calculated for the layers in the machine learning model indicates that the respective layer is a domain-sensitive layer.

Clause 3: The method of Clause 2, wherein the similarity score comprises a normalized cosine similarity score.

Clause 4: The method of any of Clauses 1 through 3, wherein the normalizing values for each respective domain-sensitive layer are updated further based on the mixing factor applied to the normalizing values for data in the source domain and 1 minus the mixing factor applied to the normalizing values for data in the shifted domain.

Clause 5: The method of Clause 4, wherein the mixing factor comprises a learnable parameter fixed for the machine learning model prior to deployment.

Clause 6: The method of any of Clauses 1 through 5, wherein the normalizing values for the data in the shifted domain comprise an average and a standard deviation calculated over the data in the shifted domain.

Clause 7: The method of any of Clauses 1 through 6, further comprising generating the inputs in the shifted domain by applying one or more transformations to the inputs in the source domain.

Clause 8: The method of any of Clauses 1 through 7, wherein the inputs in the shifted domain comprise inputs obtained at inference time.

Clause 9: The method of any of Clauses 1 through 8, further comprising deploying the machine learning model with the updated normalizing values for each respective domain-sensitive layer of the one or more domain-sensitive layers in the machine learning model.

Clause 10: The method of any of Clauses 1 through 9, further comprising defining the normalizing values for the data in the source domain as one or more constants in the machine learning model.

Clause 11: The method of any of Clauses 1 through 10, further comprising: receiving input data; generating one or more inferences based on the received input data and the machine learning model with the updated normalizing values for each respective domain-sensitive layer of the one or more domain-sensitive layers in the machine learning model; and taking one or more actions based on the generated one or more inferences.

Clause 12: A processing system comprising: a memory comprising computer-executable instructions; and one or more processors configured to execute the computer-executable instructions and cause the processing system to perform a method in accordance with any of Clauses 1-11.

Clause 13: A processing system, comprising means for performing a method in accordance with any of Clauses 1-11.

Clause 14: A non-transitory computer-readable medium comprising computer-executable instructions that, when executed by one or more processors of a processing system, cause the processing system to perform a method in accordance with any of Clauses 1-11.

Clause 15: A computer program product embodied on a computer-readable storage medium comprising code for performing a method in accordance with any of Clauses 1-11.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or a processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method, comprising:
identifying one or more domain-sensitive layers in a machine learning model based on differences between outputs generated by one or more layers in the machine learning model for inputs in a source domain and inputs in a shifted domain;
updating normalizing values for each respective domain-sensitive layer of the one or more domain-sensitive layers based on a mixing factor, fixed normalizing values for data in the source domain, and calculated normalizing values for data in the shifted domain; and
applying the updated normalizing values to each respective domain-sensitive layer of the one or more domain-sensitive layers in the machine learning model.

2. The method of claim 1, wherein identifying the one or more domain-sensitive layers in the machine learning model comprises, for each respective layer of the layers in the machine learning model:
calculating a source domain gradient vector for the respective layer based on forward-propagating and backpropagating the inputs in the source domain through the respective layer;
calculating a domain-shifted gradient vector for the respective layer based on forward-propagating and backpropagating the inputs in the shifted domain through the respective layer; and
calculating a similarity score between the source domain gradient vector and the domain-shifted gradient vector, wherein a similarity score above a threshold percentile of scores across similarity scores calculated for the layers in the machine learning model indicates that the respective layer is a domain-sensitive layer.

3. The method of claim 2, wherein the similarity score comprises a normalized cosine similarity score.

4. The method of claim 1, wherein the normalizing values for each respective domain-sensitive layer are updated further based on the mixing factor applied to the normalizing values for data in the source domain and 1 minus the mixing factor applied to the normalizing values for data in the shifted domain.

5. The method of claim 4, wherein the mixing factor comprises a learnable parameter fixed for the machine learning model prior to deployment.

6. The method of claim 1, wherein the normalizing values for the data in the shifted domain comprise an average and a variance calculated over the data in the shifted domain.

7. The method of claim 1, further comprising generating the inputs in the shifted domain by applying one or more transformations to the inputs in the source domain.

8. The method of claim 1, wherein the inputs in the shifted domain comprise inputs obtained at inference time.

9. The method of claim 1, further comprising deploying the machine learning model with the updated normalizing values for each respective domain-sensitive layer of the one or more domain-sensitive layers in the machine learning model.

10. The method of claim 1, further comprising defining the normalizing values for the data in the source domain as one or more constants in the machine learning model.

11. The method of claim 1, further comprising:
receiving input data;
generating one or more inferences based on the received input data and the machine learning model with the updated normalizing values for each respective domain-sensitive layer of the one or more domain-sensitive layers in the machine learning model; and
taking one or more actions based on the generated one or more inferences.

12. A system, comprising:
a memory having executable instructions stored thereon; and
at least one processor configured to execute the executable instructions to cause the system to:
identify one or more domain-sensitive layers in a machine learning model based on differences between outputs generated by one or more layers in the machine learning model for inputs in a source domain and inputs in a shifted domain;
update normalizing values for each respective domain-sensitive layer of the one or more domain-sensitive layers based on a mixing factor, fixed normalizing values for data in the source domain, and calculated normalizing values for data in the shifted domain; and
apply the updated normalizing values to each respective domain-sensitive layer of the one or more domain-sensitive layers in the machine learning model.

13. The system of claim 12, wherein in order to identify the one or more domain-sensitive layers in the machine learning model, the at least one processor is configured to cause the system to, for each respective layer of the layers in the machine learning model:
calculate a source domain gradient vector for the respective layer based on forward-propagating and backpropagating the inputs in the source domain through the respective layer;
calculate a domain-shifted gradient vector for the respective layer based on forward-propagating and backpropagating the inputs in the shifted domain through the respective layer; and
calculate a similarity score between the source domain gradient vector and the domain-shifted gradient vector, wherein a similarity score above a threshold percentile of scores across similarity scores calculated for the layers in the machine learning model indicates that the respective layer is a domain-sensitive layer.

14. The system of claim 13, wherein the similarity score comprises a normalized cosine similarity score.

15. The system of claim 12, wherein the normalizing values for each respective domain-sensitive layer are updated further based on the mixing factor applied to the normalizing values for data in the source domain and 1 minus the mixing factor applied to the normalizing values for data in the shifted domain.

16. The system of claim 15, wherein the mixing factor comprises a learnable parameter fixed for the machine learning model prior to deployment.

17. The system of claim 12, wherein the normalizing values for the data in the shifted domain comprise an average and a standard deviation calculated over the data in the shifted domain.

18. The system of claim 12, wherein the at least one processor is further configured to cause the system to generate the inputs in the shifted domain by applying one or more transformations to the inputs in the source domain.

19. The system of claim 12, wherein the inputs in the shifted domain comprise inputs obtained at inference time.

20. The system of claim 12, wherein the at least one processor is further configured to cause the system to deploy the machine learning model with the updated normalizing values for each respective domain-sensitive layer of the one or more domain-sensitive layers in the machine learning model.

21. The system of claim 12, wherein the at least one processor is further configured to cause the system to deploy the normalizing values for the data in the source domain as one or more constants in the machine learning model.

22. The system of claim 12, wherein the at least one processor is further configured to cause the system to:
receive input data;
generate one or more inferences based on the received input data and the machine learning model with the updated normalizing values for each respective domain-sensitive layer of the one or more domain-sensitive layers in the machine learning model; and
take one or more actions based on the generated one or more inferences.

23. A system, comprising:
means for identifying one or more domain-sensitive layers in a machine learning model based on differences between outputs generated by one or more layers in the machine learning model for inputs in a source domain and inputs in a shifted domain;
means for updating normalizing values for each respective domain-sensitive layer of the one or more domain-sensitive layers based on a mixing factor, fixed normalizing values for data in the source domain, and calculated normalizing values for data in the shifted domain; and
means for applying the updated normalizing values to each respective domain-sensitive layer of the one or more domain-sensitive layers in the machine learning model.

24. The system of claim 23, wherein the means for identifying the one or more domain-sensitive layers in the machine learning model comprises, for each respective layer of the layers in the machine learning model:
means for calculating a source domain gradient vector for the respective layer based on forward-propagating and backpropagating the inputs in the source domain through the respective layer;
means for calculating a domain-shifted gradient vector for the respective layer based on forward-propagating and backpropagating the inputs in the shifted domain through the respective layer; and
means for calculating a similarity score between the source domain gradient vector and the domain-shifted gradient vector, wherein a similarity score above a threshold percentile of scores across similarity scores calculated for the layers in the machine learning model indicates that the respective layer is a domain-sensitive layer.

25. The system of claim 23, wherein the normalizing values for each respective domain-sensitive layer are updated further based on the mixing factor applied to the normalizing values for data in the source domain and 1 minus the mixing factor applied to the normalizing values for data in the shifted domain.

26. The system of claim 25, wherein the mixing factor comprises a learnable parameter fixed for the machine learning model prior to deployment.

27. The system of claim 23, further comprising means for generating the inputs in the shifted domain by applying one or more transformations to the inputs in the source domain.

28. The system of claim 23, further comprising means for deploying the machine learning model with the updated normalizing values for each respective domain-sensitive layer of the one or more domain-sensitive layers in the machine learning model.

29. The system of claim 23, further comprising:
means for receiving input data;
means for generating one or more inferences based on the received input data and the machine learning model with the updated normalizing values for each respective domain-sensitive layer of the one or more domain-sensitive layers in the machine learning model; and
means for taking one or more actions based on the generated one or more inferences.

30. A non-transitory computer-readable medium having executable instructions stored thereon which, when executed by at least one processor, perform an operation comprising:
identifying one or more domain-sensitive layers in a machine learning model based on differences between outputs generated by one or more layers in the machine learning model for inputs in a source domain and inputs in a shifted domain;
updating normalizing values for each respective domain-sensitive layer of the one or more domain-sensitive layers based on a mixing factor, fixed normalizing values for data in the source domain, and calculated normalizing values for data in the shifted domain; and
applying the updated normalizing values to each respective domain-sensitive layer of the one or more domain-sensitive layers in the machine learning model.
